(19) United States
(12) Patent Application Publication
(10) Pub. No.: US 2018/0338481 A1
(43) Pub. Date: Nov. 29, 2018

(54) Offshore Shade Platform For Attracting Fish

(71) Applicants: Bryan Anthony Willis, Hamlet, NC (US); Stanley Craig Godwin, Williamston, NC (US)

(72) Inventors: Bryan Anthony Willis, Hamlet, NC (US); Stanley Craig Godwin, Williamston, NC (US)

(21) Appl. No.: 15/979,710

(22) Filed: May 15, 2018

Related U.S. Application Data
(60) Provisional application No. 62/510,287, filed on May 24, 2017.

(51) Int. Cl. A01K 97/02; A01K 93/02

(52) U.S. Cl. CPC A01K 97/02; A01K 93/02

(57) ABSTRACT

An offshore shade platform includes a flexible body that floats on a surface of a body of water. The flexible body provides a shaded area in which fish can congregate. A buoyancy device positioned under the flexible body supports a middle portion of the offshore shade platform on the surface of the water, and a visual indicator that helps users locate the platform extends in a substantially upright orientation from a top surface of the flexible body. To entice the fish into the shaded area, a porous counterweight containing chum hangs beneath the flexible body. Additionally, the porous counterweight provides a downward force that maintains the visual indicator in the upright orientation.

### RELATED APPLICATIONS

This application claims the benefit of priority of U.S. Provisional Application No. 62/510,287 filed on May 24, 2017, the disclosure of which is incorporated herein by reference in its entirety.

### FIELD OF THE INVENTION

The present invention relates generally to fishing equipment, and more particularly to floating devices used for attracting fish.

### BACKGROUND

Fishing is an extremely popular activity in the United States. According to a 2015 report by the National Oceanic and Atmospheric Administration (NOAA), recreational fishing contributed over $36 billion to the U.S. economy accounting for over 37% of the total value added by both recreational and commercial fishing (see https://www.st.nmfs.noaa.gov/Assets/economics/publications/FEUS/FEUS-2015/Report-Chapters/FEUS%202015%20AII% 20Chapters_Final4_508.pdf). Further, by some estimates, over 51 million people went fishing in 2017 in the United States alone. Of course, these numbers only increase when one considers both the recreational and commercial fishing industries on a global scale.

### SUMMARY

Embodiments of the present disclosure provide a floating offshore shade for attracting fish. In one embodiment, an offshore shade platform configured to attract fish comprises a flexible body, a buoyancy device, and a porous counterweight. The flexible body comprises one or more tubular receivers secured at a perimeter of the flexible body. Each of the one or more tubular receivers is configured to receive a corresponding floatation device that supports the flexible body on a surface of a body of water. The buoyancy device, which is disposed under a middle portion of the flexible body, is configured to support the middle portion of the flexible body on the surface of the water. The porous counterweight is disposed below the surface of the water and is coupled to, and supported by, the buoyancy device. The porous counterweight is configured to receive chum material that attracts fish into a shaded area underneath the flexible body.

In another embodiment, an offshore shade platform configured to attract fish comprises a flexible body, a buoyancy device, a visual indicator, and a porous chum container. The flexible body is configured to be disposed on a surface of a body of water, and to provide a shaded area to attract fish. The buoyancy device is positioned under a middle portion of the flexible body and is configured to maintain the middle portion of the flexible body on the surface of the water. The visual indicator is coupled to the buoyancy device and is configured to extend in a substantially upright orientation from a top surface of the flexible body. The porous chum container, which is also coupled to and supported by the buoyancy device, is configured to exert a downward force on the buoyancy device to maintain the visual indicator in the substantially upright orientation.

Of course, those skilled in the art will appreciate that the present invention is not limited to the above contexts or examples and will recognize additional features and advantages upon reading the following detailed description and upon viewing the accompanying drawings.

### BRIEF DESCRIPTION OF THE DRAWINGS

FIGS. 1A-1B illustrate an offshore shade platform configured to attract fish according to one embodiment of the present disclosure.

FIG. 2 illustrates a construction of an offshore shade platform according to one embodiment of the present disclosure.

FIGS. 3A-3B illustrate an offshore shade platform configured to attract fish according to another embodiment of the present disclosure.

FIG. 4 illustrates an offshore shade platform configured to attract fish and having a drift control device according to another embodiment of the present disclosure.

### DETAILED DESCRIPTION

Aspects of the present disclosure provide an offshore shade platform for attracting fish. According to the present disclosure, the offshore shade platform comprises a flexible, textile-based body that floats on a surface of a body of water. The flexible body provides a shaded area under the surface of the water in which fish can congregate. To further entice the fish into the shaded area, a porous counterweight containing chum material hangs from the flexible body and below the surface of the water. A buoyancy device disposed under the flexible body supports a middle portion of the offshore shade platform on the surface of the water. A signal device, such as a flag or a light, for example, extends in a substantially upright orientation from a top surface of the flexible body to provide a visual indicator that helps users locate the offshore shade platform floating on the surface.

The porous counterweight is configured to provide multiple functions. First, as stated above, the porous counterweight contains a chum material to help attract the fish into the shaded area of the flexible body. Second, both the porous counterweight and the signal device are connected to the buoyancy device. The weight of the porous counterweight, regardless of whether it contains the chum material, provides a downward force on the buoyancy device and/or the signal device that helps maintain the signal device in the substantially upright orientation.

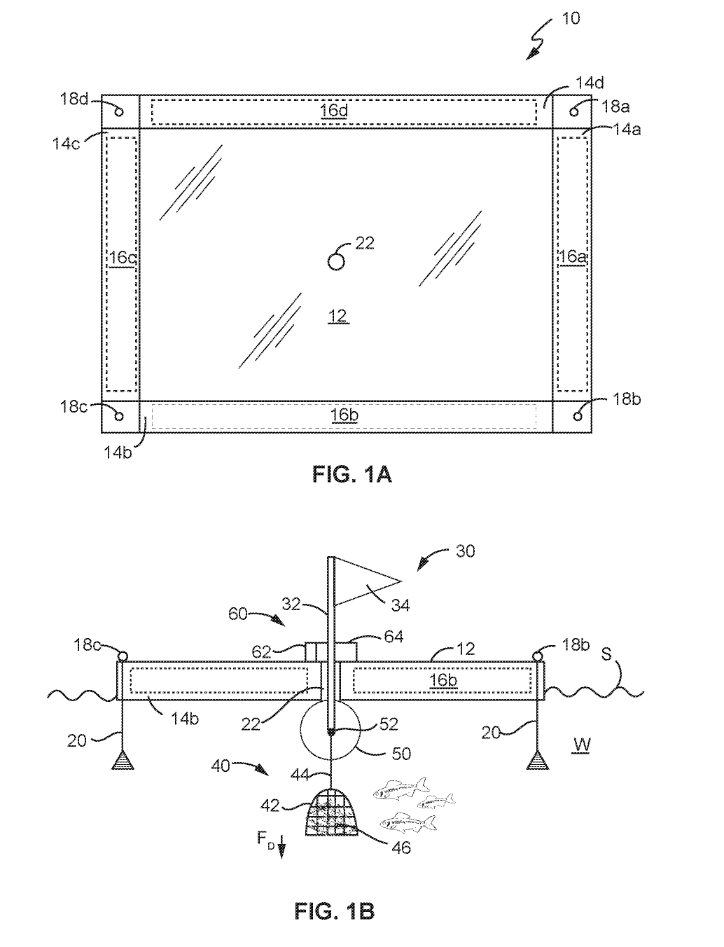

Turning now to the drawings, FIGS. 1A-1B illustrate an offshore shade platform 10 configured according to one embodiment of the present disclosure. As seen in this embodiment, platform 10 comprises a flexible body 12 having a plurality of elongated tubular receivers 14a, 14b, 14c, 14d (collectively, 14) formed on a perimeter of flexible body 12. The flexible body 12 is configured to rest on a surface S of a body of water W, and provides a shaded area underneath to attract fish. Flexible body 12 may be manufactured from any desired material, but in this embodiment, flexible body 12 comprises a unitary sheet of a textile material such as a net or a tightly weaved material. Similarly, flexible body may be of any shape and size desired. For example, in one embodiment, flexible body 12 comprises a unitary sheet of material that is six feet square. In another embodiment, however, flexible body 12 comprises a unitary sheet of material that is twelve feet square. Regardless of its shape and/or size, however, flexible body 12 can be easily rolled or folded by a user, thereby facilitating storage when not in use.

Each tubular receiver 14 formed at the perimeter of flexible body 12 is configured to receive a corresponding floatation device 16a, 16b, 16c, 16d (collectively, 16) that is inserted thereto. The floating devices 16 may comprise any type of object that is buoyant. In one embodiment, for example, the floatation devices 16, which may or may not be at least partially hollow, comprise elongated pieces of polyethylene foam that support the flexible body 12 on the surface of the water. One example of a suitable piece of foam is commonly referred to as a “pool noodle.” In other embodiments, the floatation devices 16 comprise tubes of polyvinyl chloride (PVC). In these latter embodiments, the open ends of the PVC tubes are sealed and inserted into corresponding tubular receivers 14. Sealing the PVC tubes traps the air inside the tubes thereby configuring the PVC tubes as floatation devices 16 that support the flexible body 12 on the surface of the water.

The platform 10 of FIGS. 1A-1B also comprises a plurality of anchors 20 operatively connected to the flexible body 12 via corresponding connection points 18a, 18b, 18c, 18d (collectively, 18) positioned proximate the perimeter of flexible body 12. Specifically, each anchor 20, which comprises a metal weight or other mass, for example, hangs below the surface S of the water W, and is connected to flexible body 12 using any type of mechanical fastener known in the art. In one embodiment, for example, hooks attached to anchors 20 via a cord or rope are releasably coupled to platform 10 proximate the corners of the flexible body 12.

Those of ordinary skill in the art will readily appreciate that connection points 18 may be positioned anywhere on the flexible body 12 without limitation. However, in this embodiment, the connection points 18, and thus, the anchors 20, are positioned at substantially equidistant intervals along the perimeter of flexible body 12. In this configuration, the plurality of anchors 20 provides a substantially uniform downward force on the perimeter of the flexible body 12, thereby helping to maintain the flexible body 12 on the surface S of water W.

As seen in FIG. 1B, platform 10 also comprises a signal device 30, a porous counterweight 40, and a buoyancy device 50. The signal device 30, which is connected to and supported by the buoyancy device 50, comprises a rigid or semi-rigid pole 32 extending through a through-hole 22 formed in a middle portion of the flexible body 12 to the buoyancy device 50, and a signal flag 34. In these embodiments, the signal flag 34 comprises a brightly-colored piece of flexible material such as plastic. However, those of ordinary skill in the art will appreciate that the present disclosure is not so limited. In other embodiments, for example, the signal flag 34 can be replaced by, or augmented with, a signal light configured to pulse on and off (e.g., a strobe light). Other types of visual indicators are also possible with the present embodiments; however, regardless of the type of visual indicator connected to pole 32, signal device 30 enhances the visibility of the platform 10 floating on the surface S of water W.

The porous counterweight 40 comprises a cage 42 or similar type of porous container suspended beneath flexible body 12. In particular, cage 42 is connected to the buoyancy device 50 via a chain 44 or similar mechanism and hangs beneath the flexible body 12. Cage 42 is configured to contain a chum material 46 that attracts fish into the shaded area underneath flexible body 12, but also functions as a counterweight that helps to maintain the signal device 30 in an upright orientation.

Specifically, both the signal device 30 and the porous container 40 are connected to the buoyancy device 50. In some embodiments, although not required, both the signal device 30 and the porous container 40 connect to a common connection point 52 in or on buoyancy device 50. In some situations, the wind or other natural force can be strong enough to push the signal device 30 over or onto its side, thereby decreasing the visibility of platform 10 to a user. However, cage 42 is of a sufficient weight so as to provide a downward force F_{D} on the buoyancy device 50. This downward force F_{D} helps maintain the signal device 30 in its intended upright orientation. So oriented, the signal device 30 remains highly visible to a user.

The buoyancy device 50, which in this embodiment also comprises polyethylene foam, is disposed under flexible body 12 and supports a middle portion of the flexible body 12 on the surface S of water W. In some embodiments, the buoyancy device 50 comprises a piece of polyethylene foam and is configured to be inserted into a tubular receiver formed under the middle portion of the flexible body 12. Such placement helps ensure that the buoyancy device 50 remains substantially in position under a middle portion of the flexible body 12. However, as those of ordinary skill in the art will appreciate, this particular type of attachment is not required. In other embodiments, buoyancy device 50 is attached to the perimeter of flexible body 12 via one or more tethers such that buoyancy device 50 remains substantially in-position under the middle portion of flexible body 12.

The signal device 30 enhances the visibility of platform 10 to a user. In some cases, however, such visibility may be inadequate with which to locate platform 10. By way of example only, platform 10 may be carried on the surface S of water W a far distance by a fast moving current. In such situations, the signal device 30 may be too far away from the user to be visible. Thus, in one embodiment, the present disclosure enhances the ability of the user to locate platform 10 by equipping the platform 10 with a Global Positioning Satellite (GPS) device 60 comprising a GPS receiver 62 and a transmitter 64.

Particularly, GPS receiver 62 communicates with a plurality of satellites in orbit around the earth. Based on signals received from those satellites, GPS receiver 62 computes its geographical coordinates on the earth's surface using well-known computational processes. GPS receiver 62 then sends the resultant geographical coordinates to the transmitter 64, which transmits those coordinates to a receiver associated with the user via any of a plurality of well-known air interfaces. Upon receipt, the user will know the geographical coordinates of platform 10, and thus, be able locate platform 10 even though the user cannot currently see platform 10.

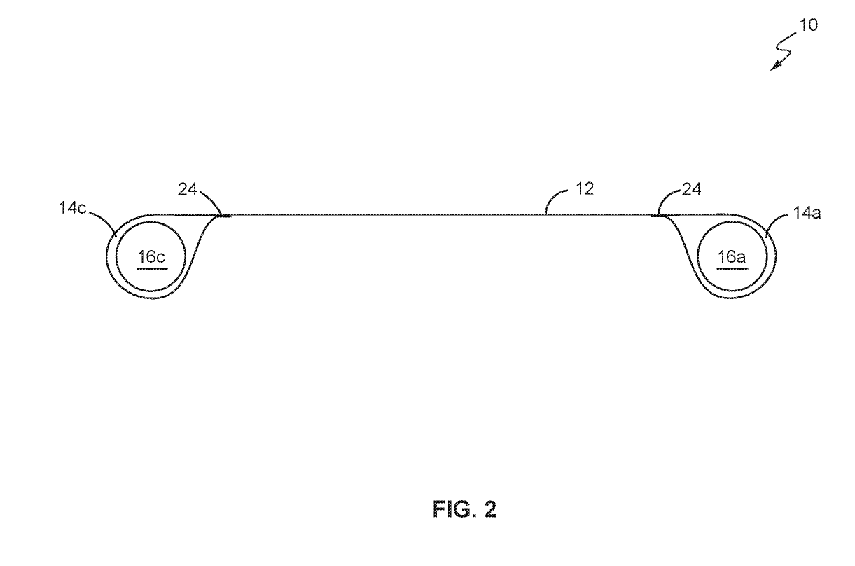

There are a variety of different ways in which to secure floatation devices 16 to flexible body 12. As seen in FIG. 2, for example, one embodiment loops the edges of flexible body 12 underneath itself and hems 24 the peripheral edge of flexible body 12 to an underside of flexible body 12. Such hemming may, for example, comprise stitching or otherwise bonding the peripheral edge of flexible body 12 to the underside of flexible body 12. This method creates the elongated tubular receivers 14 that are configured to receive the corresponding elongated floatation devices 16.

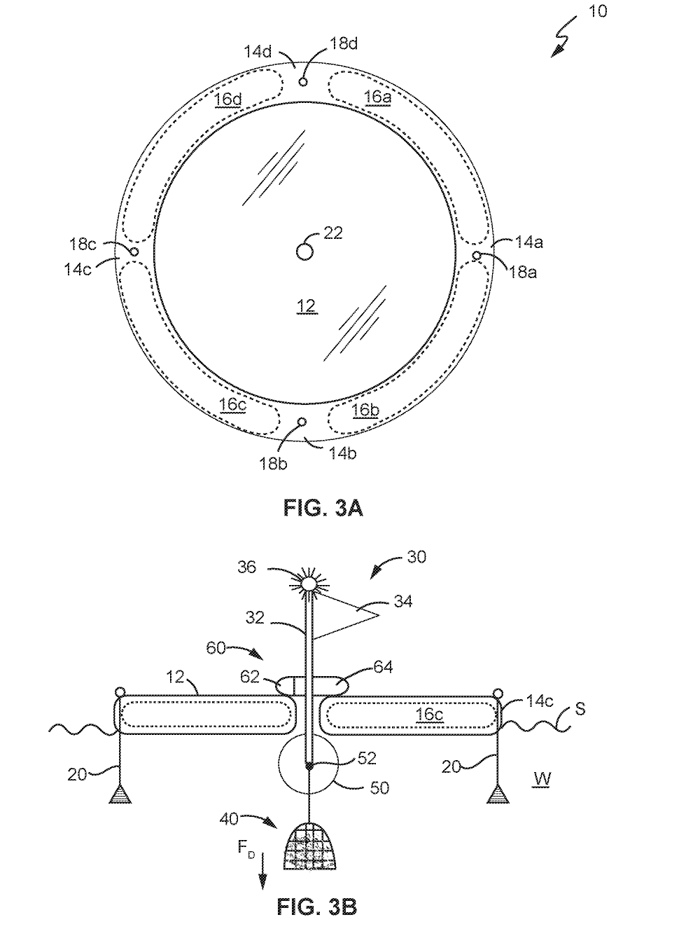

The present invention may, of course, be carried out in ways other than those specifically set forth herein without departing from essential characteristics of the invention. For example, the previous embodiments illustrate a geometry of platform 10 as being a polygon. However, those of ordinary skill in the art will readily appreciate that the present disclosure is not so limited. In another embodiment, such as the one seen in FIGS. 3A-3B, for example, platform 10 is circularly shaped. Regardless of the particular geometry, however, platform 10 comprises a buoyancy device 50 disposed under a middle portion of the flexible body 12 to support that portion of flexible body 12 on the surface S of water W, and a porous counterweight 40 suspended beneath the flexible body 12 and below the surface S of water W. Further, the porous counterweight 40, which is configured to contain a chum material to attract fish, provides a downward force F_{D} that helps maintain the signal device 30, which in this aspect also comprises a signal light L in addition to flag 34, in an upright orientation, as previously described.

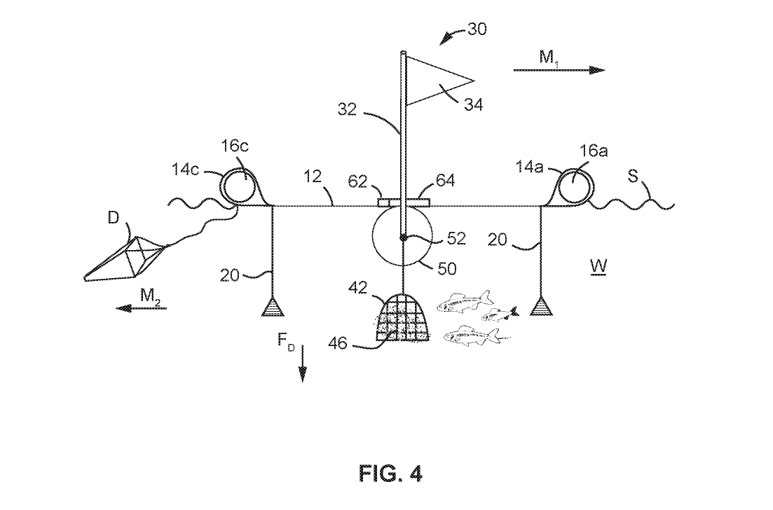

Additionally, in some cases, platform 10 may be pushed by the wind in a first direction M₁. To help control such motion, one embodiment of the present disclosure, seen in FIG. 4, equips platform 10 with a drift control device, such as drift sock D. In these embodiments, drift sock D is a generally conically-shaped tightly-weaved net, bag, or sack, for example, that is open on both ends. As seen in FIG. 4, drift sock D is attached to platform 10 and placed into the water W. In operation, the drift sock D fills up with water W as the water W flows through the drift sock D. This action creates a drag M₂ on platform 10 that helps to resist the motion of the platform 10 in the first direction M₁. Thus, drift sock D helps control the speed of the platform 10 through the water W. However, it can also help control the direction in which platform 10 travels, as well as its orientation with respect to the wind. The drift sock D can be any shape or size desired; however, according to aspects of the disclosure, drift sock D is sized considering the size of platform 10. Specifically, the drift socks D for larger sized platforms 10 will generally be larger in size than those associated with smaller-sized platforms 10. Other factors that may be considered when equipping platform 10 with a drift sock D is the speed of the wind. Particularly, faster winds will require larger drift socks D to create more drag on platform 10.

Therefore, the present embodiments are to be considered in all respects as illustrative and not restrictive, and all changes coming within the meaning and equivalency range of the appended claims are intended to be embraced therein.

What is claimed is:

1. An offshore shade platform configured to attract fish, the platform comprising:
a flexible body comprising one or more tubular receivers secured at a perimeter of the flexible body, wherein each of the one or more tubular receivers is configured to receive a corresponding floatation device that supports the flexible body on a surface of a body of water;
a buoyancy device disposed under a middle portion of the flexible body, wherein the buoyancy device is configured to support the middle portion of the flexible body on the surface of the water; and
a porous counterweight disposed below the surface of the water, wherein the porous counterweight is coupled to, and supported by, the buoyancy device and is configured to receive chum material that attracts fish into a shaded area underneath the flexible body.

2. The offshore shade platform of claim 1 further comprising a signal device operatively connected to the platform, the signal device comprising:
a pole coupled to and supported by the buoyancy device, and configured to extend in a substantially upright orientation from a top surface of the flexible body; and
a visual indicator disposed at one end of the pole.

3. The offshore shade platform of claim 2 wherein the porous counterweight is further configured to exert a downward force on the buoyancy device to maintain the pole in the substantially upright orientation.

4. The offshore shade platform of claim 1 further comprising a Global Positioning Satellite (GPS) device configured to determine a geographical position of the offshore shade platform.

5. The offshore shade platform of claim 4 further comprising a transceiver communicatively coupled to the GPS device and configured to transmit the geographical position of the offshore shade platform to a remote communications device.

6. The offshore shade platform of claim 1 further comprising a plurality of weights operatively connected to the perimeter of the flexible body, and configured to hang below the surface of the water.

7. The offshore shade platform of claim 6 wherein the plurality of weights is positioned along the perimeter of the flexible body substantially equidistant from each other.

8. The offshore shade platform of claim 1 wherein the flexible body comprises a unitary sheet of a flexible textile material.

9. The offshore shade platform of claim 8 wherein the unitary sheet of flexible textile material comprises one of a net and a weave material.

10. The offshore shade platform of claim 8 wherein the one or more tubular receivers are formed by hemming the unitary sheet of flexible textile material.

11. The offshore shade platform of claim 8 wherein each floatation device is configured to be inserted into a corresponding tubular receiver.

12. An offshore shade platform configured to attract fish, the platform comprising:
a flexible body configured to be disposed on a surface of a body of water, and to provide a shaded area to attract fish;
a buoyancy device positioned under a middle portion of the flexible body and configured to maintain the middle portion of the flexible body on the surface of the water;
a visual indicator coupled to the buoyancy device and configured to extend in a substantially upright orientation from a top surface of the flexible body; and
a porous chum container coupled to and supported by the buoyancy device, and configured to exert a downward force on the buoyancy device to maintain the visual indicator in the substantially upright orientation.

13. The offshore shade platform of claim 12 further comprising one or more floatation devices secured at a perimeter of the flexible body, and configured to support the flexible body on the surface of the water.

14. The offshore shade platform of claim 13 further comprising one or more tubular receivers formed at the perimeter of the flexible body, wherein each of the one or more tubular receivers is configured to receive a corresponding floatation device inserted thereto.

15. The offshore shade platform of claim 12 further comprising:
a Global Positioning Satellite (GPS) device configured to determine a geographical position of the offshore shade platform; and
a transceiver communicatively coupled to the GPS device and configured to transmit the geographical position of the offshore shade platform to a remote communications device.

17. The offshore shade platform of claim 12 further comprising a plurality of anchors operatively connected to the perimeter of the flexible body at substantially equidistant positions.

18. The offshore shade platform of claim 12 wherein the flexible body comprises a unitary sheet of a flexible textile material.

19. The offshore shade platform of claim 18 wherein the unitary sheet of flexible textile material comprises one of a net and a weave material.

20. The offshore shade platform of claim 12 further comprising a through-hole formed in a middle portion of the flexible body, wherein the through-hole is configured to receive a portion of the visual indicator.
